(19) United States
(12) Patent Application Publication
(10) Pub. No.: US 2016/0222938 A1
(43) Pub. Date: Aug. 4, 2016

(54) EXTERNAL STARTING SYSTEM FOR VEHICLES

(71) Applicant: RunStands, INC, Brush, CO (US)

(72) Inventor: Gary Booth, Brush, CO (US)

(21) Appl. No.: 14/939,238

(22) Filed: Nov. 12, 2015

Related U.S. Application Data
(60) Provisional application No. 62/111,338, filed on Feb. 3, 2015.

(51) Int. Cl. F02N 11/12

(52) U.S. Cl. CPC F02N 11/12

(57) ABSTRACT

An external starting system for a vehicle. An example starting system includes a first stand frame having at least one roller configured to engage with a vehicle wheel. The example starting system also includes an electric starter operably associated with the at least one roller. The electric starter actuates to rotate the at least one roller to drive a wheel of the vehicle and start an engine of the vehicle while the vehicle remains in a substantially stationary position.

### PRIORITY CLAIM

This application claims the priority filing date of U.S. Provisional Patent Application No. 62/111,338 filed Feb. 3, 2015 titled “Starting System” of Gary Booth, hereby incorporated by reference herein in its entirety for all that is disclosed.

### BACKGROUND

Some vehicles, such as the “sprint car,” require that the vehicle be push-started. As such, when the owner or mechanic wants to work on the engine while it is running, as is oftentimes the case, the vehicle first has to be push started and then driven to a work area. For example, if someone wants to work on the engine of a spring car in his or her garage, the vehicle has to be pushed (typically out into the street) and started, and then driven or pushed back into the garage and left running. If the engine is shut off (or turns off) and needs to be re-started, then this same sequence of push-starting the vehicle has to be repeated. Similar scenarios exist for the pit crew at the track. This is time-consuming and can be frustrating for the mechanic.

### BRIEF DESCRIPTION OF THE DRAWINGS

FIG. 1 is a perspective view of an example starting system.

FIG. 2 is an exploded perspective view of a left-side portion of the example starting system shown in FIG. 1.

FIG. 3 is another partial exploded perspective view of a right-side portion of the example starting system shown in FIG. 1.

FIG. 4 is a perspective view of an example control station for the example starting system.

### DETAILED DESCRIPTION

A starting system is described herein as it may be implemented as an external starting system for vehicles. The starting system enables starting a vehicle (e.g., a sprint car, “midget” car, super-modified car) that has no onboard starter without having to push-start the vehicle. The starting system may be used with any of a variety of different types of vehicles without any modification to the vehicle itself. Indeed, the system is not limited to any particular end-use, and for example can be implemented to start any vehicle or motor without an on-board starter (or where the on-board starter has been disabled or is otherwise not operating).

The starting system may also be implemented for testing and maintenance of the vehicle. For example, the starting system may include rollers to enable the vehicle wheels to rotate without the vehicle having to be moved.

In an example, the starting system is portable or mobile. That is, the starting system may be lifted on one side and rolled from one location to another. In addition, the starting system may be readily unassembled and loaded for transport (e.g., into the back of a pickup truck).

Before continuing, it is noted that as used herein, the terms “includes” and “including” mean, but is not limited to, “includes” or “including” and “includes at least” or “including at least.” The term “based on” means “based on” and “based at least in part on.”

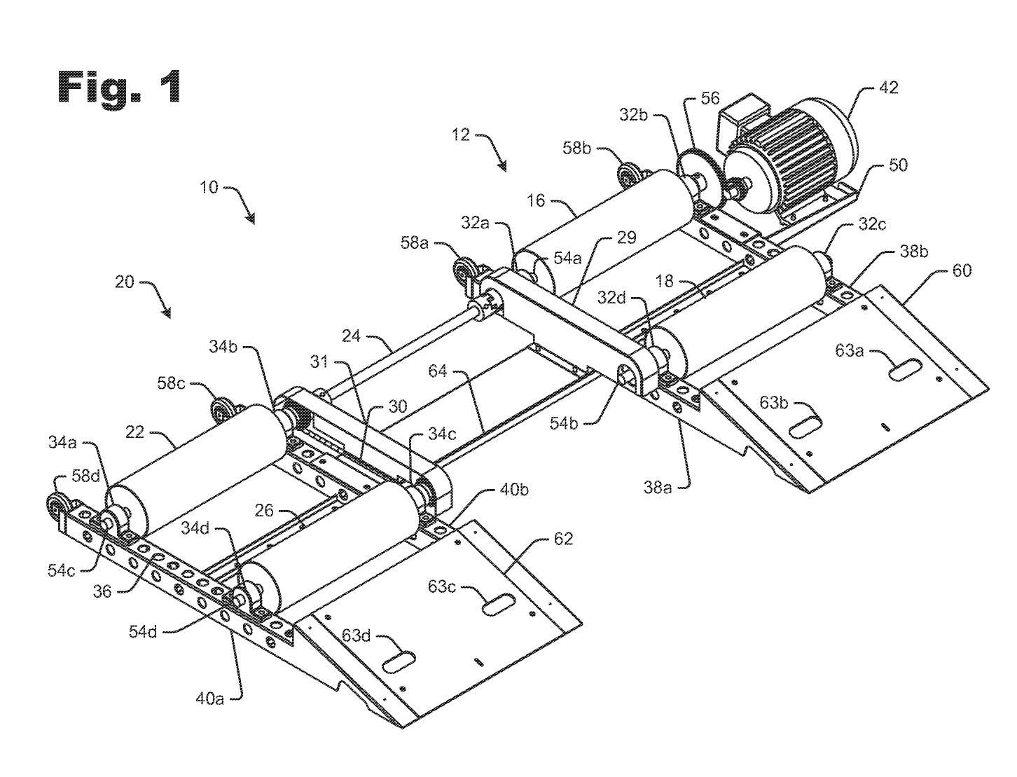

FIG. 1 is a perspective view of an example starting system 10. An example starting system 10 has a first stand frame 12. The stand frame 12 includes a drive roller 16 and a second roller 18. The drive roller 16 is spaced apart from the second roller 18 on the stand frame 12 to engage with a vehicle wheel. When a vehicle wheel is positioned on the stand frame 12 so that the vehicle wheel rests between drive roller 16 and the second roller 18.

The starting system 10 may also include a second stand frame 20. The second stand frame 20 includes a slave roller 22. A drive shaft 24 connects the drive roller 16 (on the first stand frame 12) to the slave roller 22 on the second stand frame 20. A second roller 26 on the second stand frame 20 is spaced apart from the second roller 18 on the stand frame 12 to engage with a vehicle wheel. When a vehicle wheel is positioned on the stand frame 12 so that the vehicle wheel rests between drive roller 16 and the second roller 18.

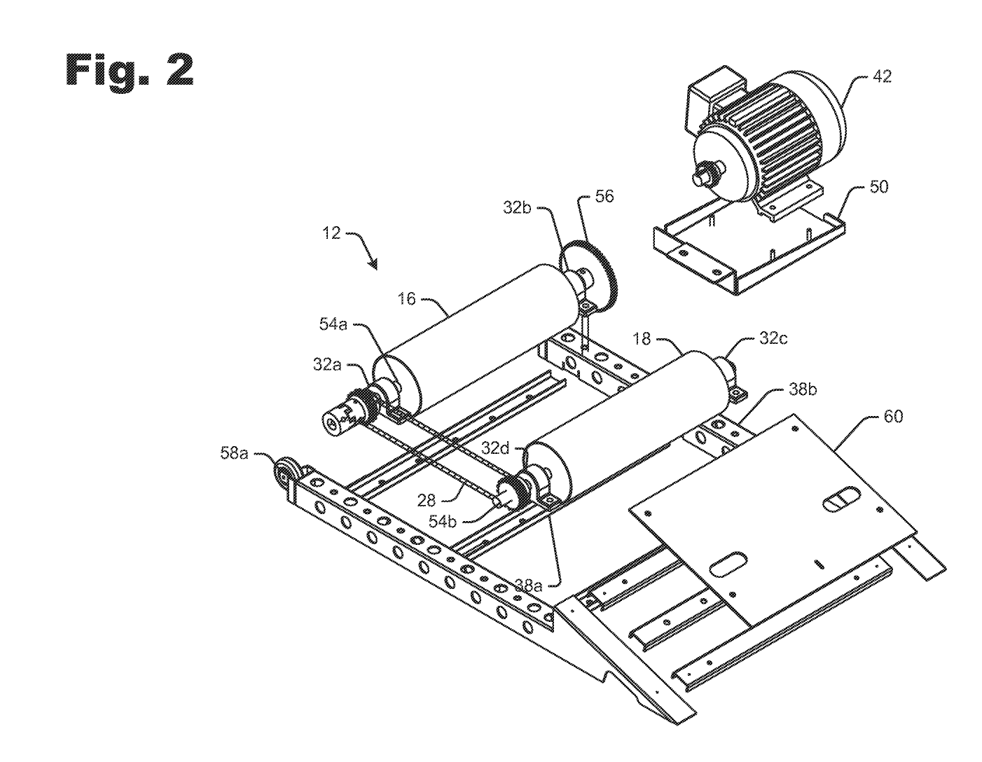

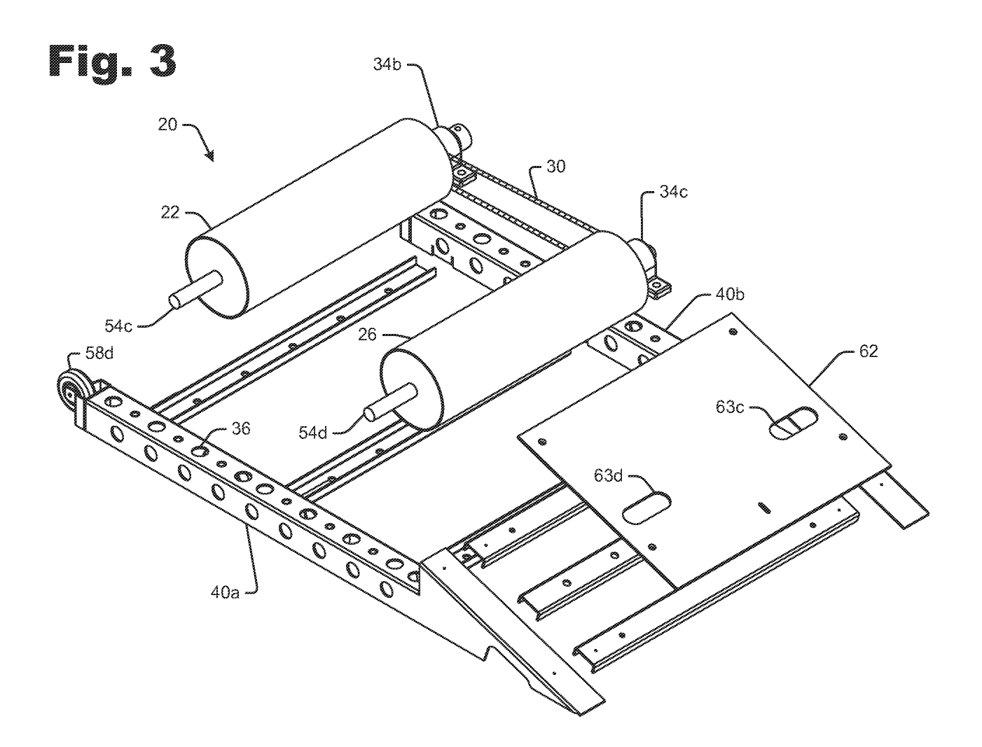

In an example, a first chain 28 (and sprocket) (under chain guard 29—chain 28 is visible in FIG. 2) connects the drive roller 16 and the second roller 18 on the first stand frame 12. A second chain 30 (and sprocket) (under chain guard 31—chain 30 is visible in FIGS. 1 and 3) connects the slave roller 22 and the second roller 26 on the second stand frame 20.

Also in an example, the drive roller 16 and the second roller 18 on the first stand frame 12, and the slave roller 22 and the second roller 26 on the second stand frame 20, are adjustable. For example, the roller mounts 32a-d supporting rollers 16 and 18, and roller mounts 34a-d supporting rollers 22 and 26, may be mounted to any of a plurality of openings (generally referred to as openings 36) in rail supports 38a-b and rail supports 40a-b. As such, the first stand frame 12 and second stand frame 20 can be adjusted to accommodate different size tires. In other examples (not shown), other adjustments may also be provided (e.g., to accommodate different heights and/or widths of the starting system 10).

In an example, the starting system 10 also includes an electric motor 42. The electric motor 42 may be powered by any suitable electrical power source (e.g., AC and/or DC). For example, the electric motor 42 may be powered by an on-board or remote battery, or connected via a power cord to an AC power source (not shown). The electric motor 42 may be actuated by an electric starter. In an example, The electric starter implements a variable Frequency Drive (VFD) to convert power from an outside source (e.g., at 220 volts AC) to an operating voltage (e.g., 480 volts AC). It is noted that operating at 480 volts AC enables the motor to provide more power and torque.

The electric starter 44 may be provided remotely from the stand frames 12 and 20. For example, the electric starter 44 may be housed with other control electronics on a stand 46. The electric motor 42 may be controlled via wired and/or wireless connection.

During operation, the electric motor 42 may be actuated by the electric starter 44. The electric motor 42 is connected to the drive roller 16 on the first stand frame 12 to rotate the drive roller 16 and rotate a wheel of the vehicle (not shown) positioned on the drive roller 16. This rotation starts an engine of the vehicle while the vehicle remains in a substantially stationary position.

Rotating the drive roller 16 causes the vehicle wheel to rotate. For example, the drive motor 42 may engage the drive roller 16. Rotating the drive roller 16 in turn rotates the second roller 18 on the first stand frame 12 via the chain 28. In addition, rotating the drive roller 16 rotates the slave roller 22 on the second stand frame 20 via drive shaft 24. The slave roller 22 in turn rotates the second roller 26 on the second stand frame 20. Rotating the vehicle wheel(s) in turn starts the vehicle engine.

Other examples of operation are also contemplated. For example, not all of the rollers need to be operated to rotate by the drive motor. In this example, one or more of the other rollers may be free-spinning. That is, the other rollers are provided to support the vehicle wheel, and rotate via rotation of the vehicle wheel (which is driven by the drive roller). In another example, separate motors may be provided for each drive stand. Still other examples will be well understood by those having ordinary skill in the art after becoming familiar with the teachings herein.

Before continuing, it should be noted that the examples described above are provided for purposes of illustration, and are not intended to be limiting. For example, the starter system shown in the drawings is illustrative of an example starting system, but is in no way limiting to any particular configuration. Other components and/or device configurations may be utilized. In addition, the starting system is not limited to any particular dimensions/size/proportions, and components of the starting system may be manufactured of any suitable material, such as but not limited to, stainless steel or powder-coated metal fabrication.

In an example, the starting system 10 includes left-side portion separable from a separate right-side portion. FIG. 2 is an exploded perspective view of a left-side portion of the example starting system 10 shown in FIG. 1, including the first stand frame 12. In an example, the left-side portion includes a drive subsystem with a 12 volt, 2,000 AMP electric starting motor 42 (although other starting motors may be provided). The drive motor 42 may be mounted on platform 50, mounted to rail support 38b. The drive subsystem may also include a gear assembly 56 configured between the starting motor 42 and the drive roller 16.

The drive roller 16 (and second roller 18) may be hollow shaft cylinders with end-caps, although solid shaft cylinders may also be provided. The drive roller 16 mounts to the rail supports 38a-b via roller shaft 54a. The roller shaft 54a extends through the cylinders and attach at roller mounts 32a-b via bearing assemblies (not shown) between the cylinder 54a and the roller mounts 32a-b. The second roller 18 mounts similarly to the rail supports 38a-b.

The first stand frame 12 may also include a non-slip drive-up ramp surface or deck plate 60. In an example, the non-slip deck plate may be diamond plated, including non-slip adhesive tape for tire tractions, and/or other non-slip surface may be provided. Handles 63a-b may also be provided. In the example show, handles 63a-b are cut in the deck plate 60. Other suitable handles may be provided to enable the first stand frame 12 to be lifted and/or tilted and moved (e.g., on casters 58a-b). Tie-downs may also be provided, e.g., to attach and hold the vehicle to the first stand frame 12.

FIG. 3 is another partial exploded perspective view of a right-side portion of the example starting system 10 shown in FIG. 1, including second stand frame 20. The right-side portion of the starting system 10 may include a slave roller 22 driven by the drive motor 42 via drive roller 16 and drive shaft 24. In another example, the drive shaft 24 may be disconnected to operate the slave roller 22 as an idler roller.

The slave roller 22 (and second roller 26) may be hollow shaft cylinders with end-caps, although solid shaft cylinders may also be provided. The slave roller 22 mounts to the rail supports 38c-d via roller shafts 54c. The roller shafts 54c extend through the cylinders and attach at roller mounts 34a-b via bearing assemblies (not shown) between the cylinder 54c and the roller mounts 34a-b. The second roller 26 mounts similarly to the rail supports 40a-b.

The first stand frame 12 may also include a non-slip drive-up ramp surface or deck plate 60. In an example, the non-slip deck plate may be diamond plated, including non-sap adhesive tape for tire tractions, and/or other non-slip surface may be provided. Handles 63c-d may also be provided. In the example show, handles 63c-d are cut in the deck plate 60. Other suitable handles may be provided to enable the first stand frame 12 to be lifted and/or tilted and moved (e.g., on casters 58c-d). Tie-downs may also be provided, e.g., to attach and hold the vehicle to the first stand frame 12.

In the example above, the vehicle may be positioned with the left rear wheel on the left-side (starter) assembly and the right rear wheel on the right-side (idler) assembly. Once positioned, the starter may be activated to rotate the left rear wheel and thus start the engine of the vehicle without the vehicle moving. The right rear wheel may also rotate on the rollers. Again, it is noted that various configurations of the starting system may be operated to spin one, both or all wheels with the gear box engaged to spin the engine until started.

It is noted that the right-side and left-side components of the starting system described above may be interconnected via support member 64 to form a single assembly (see FIG. 1). In another example, the right-side and left-side portions may be used independently. In addition, the drive subsystem may be provided on either or both side portions.

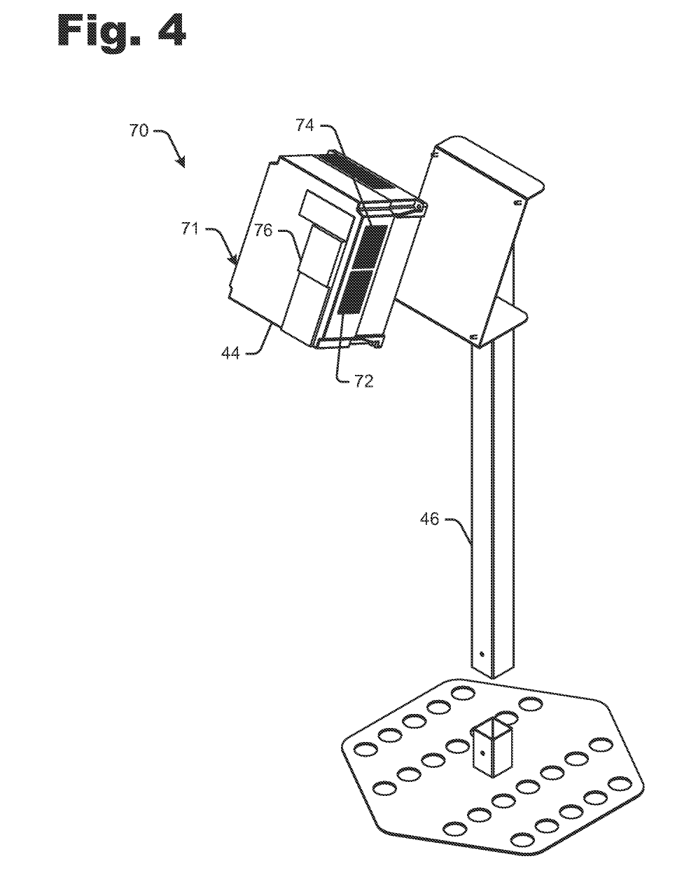

FIG. 4 is a perspective view of an example control station for the example starting system. In an example, the control station 70 includes an electrical box 71 including one or more automotive batteries, a master disconnect switch 72, an LED light 74 (e.g., green light to indicate power “ON”), and one remote starter switch 76 (a wired remote is shown for illustration, however the remote may also be wireless). It is noted, however, that the starter and/or other control electronics can be provided integral with (e.g., mounted on) one or more of the stand frames 12 and 20.

It is noted that the examples shown and described are provided for purposes of illustration and are not intended to be limiting. Still other examples are also contemplated.

1. An external starting system for a vehicle, comprising:
a first stand frame having a first roller configured to engage with a vehicle wheel; and
an electric starter operably associated with the first roller on the first stand frame, wherein the electric starter actuates to rotate the roller on the first stand frame to drive a wheel of the vehicle and start an engine of the vehicle while the vehicle remains in a substantially stationary position.

2. The starting system of claim 1, further comprising a second roller on the first stand frame.

3. The starting system of claim 2, further comprising a chain connecting the first roller and the second roller.

4. The starting system of claim 1, further comprising a ramp on the first stand frame.

5. The starting system of claim 1, further comprising a second stand frame having a first roller configured to engage another wheel of the vehicle.

6. The starting system of claim 4, further comprising a second roller on the second stand frame.

7. The starting system of claim 5, further comprising a chain connecting the first roller and the second roller.

8. The starting system of claim 4, further comprising a ramp on the second stand frame.

9. The starting system of claim 4, further comprising a drive shaft extending between the first roller of the first stand frame and the first roller of the second stand frame.

10. The starting system of claim 4, further comprising a cross support extending between the first stand frame and the second stand frame.

11. The starting system of claim 1, further comprising a plurality of positioning openings on the first stand frame, the positioning openings each configured to engage the first roller to adjust to different size tires.

12. The starting system of claim 1, further comprising a control station housing the electric starter.

13. The starting system of claim 1, further comprising an electric motor operatively associated with the electric starter, the electric motor connected to the first roller on the first stand frame to drive the first roller.

14. An external starting system for a vehicle, comprising:
a first stand frame having a drive roller configured to engage with a vehicle wheel;
a second stand frame having a slave roller connected;
a drive shaft connecting the drive roller on the first stand frame to the slave roller on the second stand frame; and
an electric starter to rotate the drive roller to rotate a wheel of the vehicle and start an engine of the vehicle while the vehicle remains in a substantially stationary position.

15. The starting system of claim 14, further comprising a second roller on the first stand frame and a second roller on the second stand frame.

16. The starting system of claim 15, further comprising:
a first chain connecting the drive roller and the second roller on the first stand frame; and
a second chain connecting the slave roller and the second roller on the second stand frame.

17. The starting system of claim 15, wherein the drive roller and the second roller on the first stand frame, and the slave roller and the second roller on the second stand frame, are adjustable to accommodate different size tires.

18. The starting system of claim 14, further comprising an electric motor actuated by the electric starter, the electric motor connected to the drive roller on the first stand frame to rotate the drive roller.

19. An external starting system fore vehicle, comprising:
a first stand frame having a drive roller configured to engage with a vehicle wheel;
a second stand frame having a slave roller;
a drive shaft connecting the drive roper on the first stand frame to the slave roller on the second stand frame;
an electric starter; and
an electric motor actuated by the electric starter, the electric motor connected to the drive roller on the first stand frame to rotate the drive roller and rotate a wheel of the vehicle to start an engine of the vehicle while the vehicle remains in a substantially stationary position.

20. The starting system of claim 19, further comprising:
a second roller on the first stand frame and a second roller on the second stand frame;
a first chain connecting the drive roller and the second roller on the first stand frame;
wherein the drive roller and the second roller on the first stand frame, and the slave roller and the second roller on the second stand frame, are adjustable to accommodate different size tires; and
a second chain connecting the slave roller and the second roller on the second stand frame.
